(19) United States
(12) Patent Application Publication
(10) Pub. No.: US 2010/0153595 A1
(43) Pub. Date: Jun. 17, 2010

(54) WIRELESS USB COMMUNICATION SYSTEM, USB HOST, AND USB DEVICE

(75) Inventors: Kenji Sakuda, Suwa-shi (JP); Yoshinao Kitahara, Suwa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/635,557

(22) Filed: Dec. 10, 2009

(30) Foreign Application Priority Data
Dec. 11, 2008 (JP) 2008-315874

(51) Int. Cl. G06F 13/12

(52) U.S. Cl. 710/63

(57) ABSTRACT

A wireless USB communication system includes: a USB host that has a first communication module for performing communication based on a wireless USB standard; and a USB device that has a second communication module for performing communication based on the wireless USB standard, another communication module for performing communication based on a standard other than the wireless USB standard, and a memory capable of storing various information. In the system, the USB host establishes connection with the USB device by sharing a connection context with the USB device in an in-band method based on the wireless USB standard.

### BACKGROUND

1. Technical Field

The present invention relates to a wireless USB communication system, a USB host, and a USB device.

2. Background Art

Generally, methods are known which transmit communication information on a communication condition of a wireless LAN communication module belonging to the USB device from a USB host to the USB device through a cable, when setting the communication condition. For example, in a network print system disclosed in JP-A-2007-157008, a PC and a printer are connected to each other through a USB interface cable, SSID and WEP keys are transmitted from the PC to the printer through the cable, and a communication condition of a wireless LAN interface (a wireless LAN communication module) of the printer is set.

However, sometimes the USB device may have not only a wireless LAN communication module, a wired USB communication module which performs communication based on a wired USB standard, and the like (other communication module) but also a wireless USB communication module which performs communication based on a wireless USB standard. In this case, for example, when a communication condition of the wireless LAN communication module of the USB device is set, the wired USB is used and the same method as described in JP-A-2007-157008 is applied, a problem arises in that the USB interface cable is needed. In particular, in a case where the wireless LAN communication module is set and the wired USB is not used after the setting, the USB interface cable is wastefully needed only for the setting. Furthermore, in a case where the communication condition is set by using the wireless LAN, it is necessary to input the setting of the wireless LAN, for example, by using an operational panel of the USB device. However, generally the operational panel of the USB device may be inconvenient in the input of the setting of the wireless LAN in a case where a size of the display is small and in a case where the number of the buttons is small.

### SUMMARY

An advantage of some aspects of the invention is to perform in a simpler way without using the cable the setting of the another communication module based on the standard other than the wireless USB standard belonging to the USB device.

In order to achieve the advantage mentioned above, the invention adopts the following means.

According to an aspect of the invention, a wireless USB communication system includes: a USB host that has a first communication module for performing communication based on a wireless USB standard; and a USB device that has a second communication module for performing communication based on the wireless USB standard, another communication module for performing communication based on a standard other than the wireless USB standard, and a memory capable of storing various information. In the system, the USB host establishes connection with the USB device by sharing a connection context with the USB device in an in-band method based on the wireless USB standard, and subsequently transmits communication information on a communication condition of the another communication module to the USB device through the first communication module. In addition, the USB device establishes connection with the USB host by sharing the connection context therewith and subsequently stores received communication information in the memory and sets a communication condition of the another communication module on the basis of the received communication information when receiving the communication information from the USB host through the second communication module.

In this wireless USB communication system, the USB host establishes connection with the USB device by sharing the connection context with the USB device in the in-band method based on the wireless USB standard, and subsequently transmits the communication information on the communication condition of the another communication module to the USB device through the first communication module. Here, the “another communication module” is a communication module other than the first and second communication modules. On the other hand, the USB device establishes connection with the USB host by sharing the connection context. Subsequently, the USB device stores the received communication information in the memory and sets the communication condition of the another communication module on the basis of the received communication information when receiving the communication information from the USB host through the second communication module. Here, when the communication condition of the another communication module is set from the USB host, it is necessary to establish the connection between the USB host and the USB device in order to transmit the communication information to the USB device. For example, when the connection is performed by using a wired USB or a wired LAN, it is necessary to use a USB cable or a LAN cable. In contrast, when the connection is preformed on the basis of the wireless USB standard and the connection context is shared between both of them in the in-band method of the wireless USB standard at the time of connection between both of them, it is not necessary to use the cable in order to connect both of them. Furthermore, when the connection is performed by the wireless LAN, it is necessary to input the setting of the wireless LAN, for example, by using the operational panel of the USB device in order to connect both of them. Generally, the operational panel of the USB device may be inconvenient in the input of the setting of the wireless LAN in a case where a size of the display is small and in a case where the number of the buttons is small. In contrast, when the wireless USB standard is used and the connection context is shared between both of them in the in-band method of the wireless USB standard at the time of connection between both of them, it is not necessary to input the setting of the wireless LAN by using the operational panel and the like which are inconvenient in the input in order to connect both of them. Accordingly, it is possible to perform the setting of the another communication module, which belongs to the USB device, based on the standard other than the wireless USB standard in a simpler way without using the cable.

In the wireless USB communication system according to the aspect of the invention, it is preferred that the another communication module be a wireless LAN communication module or a wired LAN communication module. Generally, the wireless LAN communication module and the wired LAN communication module have a plurality of setting items, and it takes time to input the setting items by using the operational panel. Hence, it is of great significance to apply the aspect of the invention.

In the wireless USB communication system according to the aspect of the invention, it is preferred that the USB host be a PC. It is also preferred that the USB device be a printer. With such a configuration, generally the PC is more convenient to input the setting of the wireless LAN and the like than the printer. Hence, it is of great significance to apply the aspect of the invention.

According to another aspect of the invention, a USB host includes: a first communication module that communicates with a second communication module belonging to a USB device on the basis of a wireless USB standard; and a host control section that establishes connection with the USB device by sharing a connection context with the USB device in an in-band method based on the wireless USB standard, and subsequently transmits communication information on a communication condition of another communication module for performing communication based on a standard other than the wireless USB standard belonging to the USB device to the USB device through the first communication module.

In the USB host, the connection with the USB device is established by sharing the connection context with the USB device in an in-band method based on the wireless USB standard, and subsequently the communication information on a communication condition of the another communication module, which performs communication based on a standard other than the wireless USB standard belonging to the USB device, is transmitted to the USB device through the first communication module. In such a manner, the communication information is transmitted from the USB host to the USB device through the first communication module. Hence, it is possible to set the another communication module for performing communication based on the standard other than the wireless USB standard belonging to the USB device in a simpler way without using the cable.

According to a further aspect of the invention, a USB device includes: a second communication module that communicates with a first communication module belonging to a USB host on the basis of a wireless USB standard; another communication module that performs communication based on a standard other than the wireless USB standard; a memory that is able to store various information; and a device control section that establishes connection with the USB host by sharing a connection context with the USB host in an in-band method based on the wireless USB standard, and subsequently stores received communication information in the memory and sets a communication condition of the another communication module on the basis of the received communication information when receiving the communication information of the communication condition of the another communication module from the USB host through the second communication module.

In the USB device, when the communication condition of the another communication module is set, the USB device establishes the connection with the USB host by sharing the connection context with the USB host in the in-band method of the wireless USB standard. Subsequently, when receiving the communication information on the communication condition of the another communication module from the USB host through the second communication module, the USB device stores the communication information in the memory, and sets the communication condition of the another communication module. Accordingly, it is possible to set in a simpler way without using the cable the another communication module for performing communication based on the standard other than the wireless USB standard belonging to the USB device.

### BRIEF DESCRIPTION OF THE DRAWINGS

The invention will be described with reference to the accompanying drawings, wherein like numbers reference like elements.

FIG. 1 is an explanatory diagram illustrating a configuration of a wireless USB communication system.

FIG. 2 is a flowchart illustrating an example of a wireless LAN setting process routine.

FIG. 3 is an explanatory diagram illustrating an example of the connection start confirmation screen.

FIGS. 4A, 4B, 4C, 4D, and 4E are explanatory diagrams illustrating an example of various screens displayed on a display.

FIG. 5 is an explanatory diagram of information stored in a HDD after setting of a wireless LAN.

FIG. 6 is an explanatory diagram of information stored in a flash memory after the setting of the wireless LAN.

### DESCRIPTION OF EXEMPLARY EMBODIMENTS

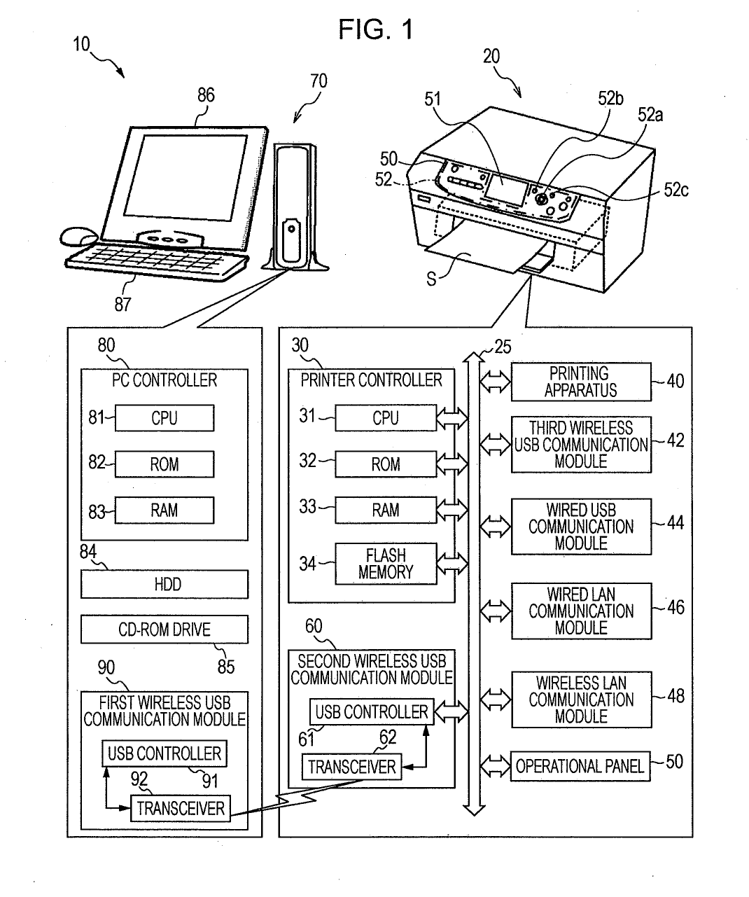

Next, embodiments of the invention will be described with reference to the accompanying drawings. FIG. 1 is a diagram schematically illustrating a configuration of a wireless USB communication system 10. The wireless USB communication system 10 functions as the USB device, and includes a printer 20 for printing image data and a PC 70 as a USB host for exchanging information with the printer 20 on the basis of the wireless USB standard.

The printer 20 includes a printing apparatus 40, an operational panel 50, a second wireless USB communication module 60, a third wireless USB communication module 42, a wired USB communication module 44, a wired LAN communication module 46, a wireless LAN communication module 48, and a printer controller 30.

The printing apparatus 40 is formed as a known ink jet color printer for performing printing by ejecting ink onto the printing paper S form a printing head on the basis of a print job which is a target of print instruction when receiving the print instruction from the printer controller 30.

The operational panel 50 is a device by which a user inputs various instructions to the printer 20, and includes a display section 51 on which characters and images corresponding to the various instructions are displayed and a operational section 52 in which the instructions of the user can be input by various keys. The various keys include a cursor key 52a formed of four buttons (up, down, left and right), an OK key 52b formed of one button, a connection check key 52c and the like.

The second and third wireless USB communication modules 60 and 42 exchange information with the USB host (for example, the PC 70) connected on the basis of the wireless USB standard. The second wireless USB communication module 60 includes a USB controller 61 which controls the exchange of the information with the USB host and a transceiver 62 which wirelessly transmits and receives the information with the USB host. In order to establish connection with the first wireless USB communication module 90 of the PC 70, the second wireless USB communication module 60 has to share the connection context (CC: Connection Context) between both of them. Here, the CC is formed of CK (Connection Key) which is a master key shared between both of a CHID (Connection Host ID) as a unique ID of the USB host (which is the PC 70 herein) and a CDID (Connection Device ID) which is a unique ID of the USB device (which is the printer 20 herein). Furthermore, the third wireless USB communication module 42 has the same configuration as the second wireless USB communication module 60 although not illustrated in detail.

The wired USB communication module 44 exchanges information between the printer 20 and the PC and the like connected to the wired USB communication module 44 through a USB cable.

Wired LAN communication module 46 exchanges information between the printer 20 and the PC, a hub, and the like connected to the wired LAN communication module 46 thorough a LAN cable. In order to exchange information with the hub, the PC, and the like by using the wired LAN communication module 46, it is necessary to set an IP address, a subnet mask, a default gateway, and the like.

The wireless LAN communication module 48 exchanges information between the computer and an access point connected on the basis of the wireless LAN standard. In order to exchange information between the computer, the access point, and the like by using the wireless LAN communication module 48, it is necessary to firstly set a communication mode (an infrastructure mode or an add-hoc mode), a SSID (Service Set Identifier), an encryption mode, an encryption key, and the like. Furthermore, it is also necessary to set the IP address, the subnet mask, the default gateway, and the like.

The printer controller 30 is formed as a microprocessor centered on a CPU 31, and includes a ROM 32 which stores various programs, a RAM 33 which is able to temporarily store data, and a flash memory 34 which is electrically rewritable and retains data even if the power is turned off. The printer controller 30 is electrically connected through a bus 25 to the printing apparatus 40, the operational panel 50, the second and third wireless USB communication modules 60 and 42, the wired USB communication module 44, the wired LAN communication module 46, and the wireless LAN communication module 48.

The PC 70 is a known normal PC, and includes a PC controller 80 which has a CPU 81 for executing various controls, a ROM 82 for storing various control programs, and a RAM 83 for temporarily storing data. The PC 70 includes a HDD 84 which is a high capacity memory for storing various data files and various application programs and a first wireless USB communication module 90 which exchanges information with the USB device (for example, printer 20) connected on the basis of the wireless USB standard. The first wireless USB communication module 90 includes a USB controller 91 which controls the information exchange with the USB device and a transceiver 92 which wirelessly transmits and receives information with the USB device. Further, the PC 70 includes a display 86 which displays various information on a screen, and an input device 87 such as a keyboard or a mouse by which a user inputs various instructions and information. The PC controller 80 inputs an operational signal generated in response to the operation of the input device 87. Furthermore, the PC controller 80 outputs a control signal to the first wireless USB communication module 90 or outputs a control signal to the display 86 so as to output various data on the basis of the wireless USB standard. Here, the PC controller 80, the HDD 84, a CD-ROM drive 85, and the first wireless USB communication module 90 are electrically connected to a bus which is not shown in the drawing.

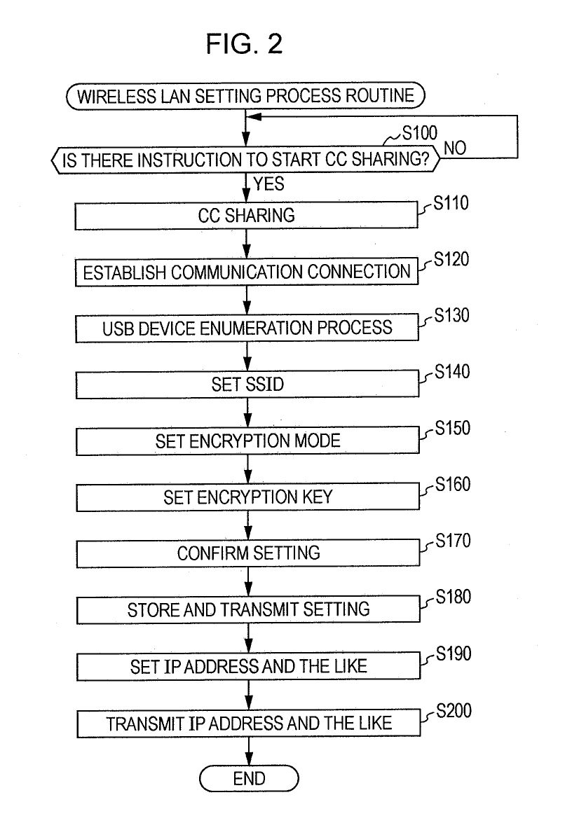

Next, the operation of the wireless USB communication system 10 according to the embodiment configured as described above, in particular, an operation performed when a user purchases the printer 20 and first sets the wireless LAN communication module 48 of the printer 20 by operating the PC 70 will be described. A process of the PC 70 is mainly described herein. FIG. 2 is a flowchart illustrating an example of a request transmission process routine which is executed by the CPU 81. The routine is executed by the following procedure. First, a user turns on the PC 70 and the printer 20, and sets the CD-ROM, which stores software for setting the printer 20, into the CD-ROM drive 85. Second, the software for setting the printer 20 is executed by operating the input device 87, and the setting of the wireless LAN communication module 48 is executed when receiving instruction therefor. Setting of the infrastructure mode is described herein.

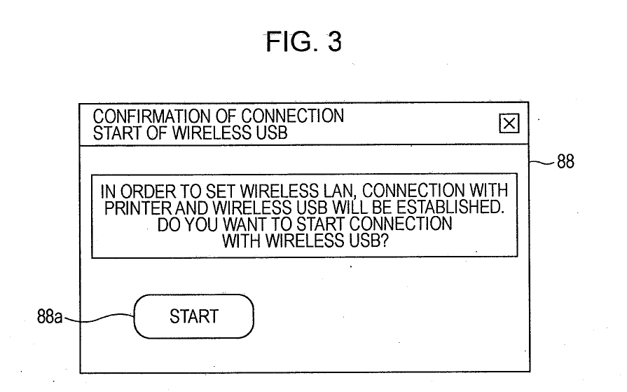

When this routine is started, first the CPU 81 determines whether or not the instruction to start the sharing of the CC is input from the second wireless USB communication module 60 of the printer 20 (step S100). Here, the sharing of the CC is started when the user operates the input device 87 of the PC 70 or the operational section 52 of the printer 20 in the following procedure. First, the user operates the operational section 52 so as to make a connection start confirmation screen 88 exemplified in FIG. 3 display on the display section 51 of the printer 20, and operates the input device 87 so as to make the same screen as shown in FIG. 3 display on the display 86 of the PC 70. As shown in the drawings, the connection start confirmation screen 88 is provided with a start button 88a. Next, the user selects the start button 88a by the cursor key 52a of the operational section 52 of the printer 20, decides the selection by the OK key 52b, and clicks the start button 88a by operating the mouse of the PC 70. In the PC 70, when the start button 88a is clicked, the instruction to start the sharing of the CC is input. In step S100, waiting for the input of the instruction to start the sharing of the CC, the CPU 81 controls the USB controller 91 to exchange public keys (Public Key cryptography), which are digit sequences, with the USB controller 61. After the exchange of the public keys, the CPU 31 controls the USB controller 61 to obtain a two-digit or four-digit hash value which can be displayed on the display 51 on the basis of both of the public keys. Then, the CPU 31 displays the obtained hash value as an authentication value on the display section 51. Furthermore, the CPU 81 controls the USB controller 91 to obtain a hash value of notified digits from the printer 20 in the same way as the USB controller 61, and subsequently displays the obtained hash value as an authentication value on the display 86. Here, the sharing of the CC is successful when the same authentication values are displayed in the PC 70 and printer 20, and is failed when different values are displayed. The user checks that the same authentication values are displayed in the PC 70 and printer 20, clicks a connection check button, which is not shown in the drawing, on the screen of the display 86, and holds down the connection check key 52c of the operational section 52. The CPU 81 generates the CK in the USB controller 91 when the connection check button, which is not shown in the drawing, on the screen of the display 86 is clicked, and shares the CK as the CC together with the CHID and the CDID between the PC 70 and the printer 20 in the so-called in-band method (step S110). Specifically, the CPU 81 controls the USB controller 91 to store the CC in the HDD 84 and to transmit the CC to the printer 20 by the transceiver 92. When receiving the CC through the transceiver 62, the CPU 31 controls the USB controller 61 to store the received CC in the flash memory 34. As described above, the CC is shared without using a cable.

Subsequently, the CPU 81 controls the USB controller 91 to establish communication connection with the printer 20 (step S120). Here, the communication connection is established, for example, by a four-way handshake. The four-way handshake is performed, for example, by making the CPU 81 control the USB controller 91 and by making the CPU 31 control the USB controller 61 to execute the following process. The PC 70 and the printer 20 mutually retain the CK. First, the USB controller 91 of the PC 70 transmits a HNonce and a TKID (Temporal Key Identifier), which are unique random numbers, to the printer 20 through the transceiver 92. The USB controller 61 of the printer 20 receiving the HNonce and the TKID generates a PTK (Pairwise Temporal Key) from the CK, the HNonce, and a DNonce which is a self-generated unique random number, and transmits the TKID and the DNonce to the PC 70 through the transceiver 62. The USB controller 91 receiving it generates a PTK from the CK, the HNonce, and the DNonce in the same manner as the USB controller 61. At this time, when retaining the same CK, the PC 70 and the printer 20 hold the same PTK. Hence, when the PTK received from the printer 20 and the self-generated PTK coincide with each other by comparing them with one another; it is possible to determine that the PC 70 and the printer 20 retain the same CK. The USB controller 91 verifies that the PTK received from the printer 20 coincides with the self-generated PTK, and transmits instruction to use the PTK generated by the USB controller 61 to the printer 20. The USB controller 61 receiving it starts the use of the self-generated PTK, and transmits such a context to the PC 70. The USB controller 91 receiving it starts the use of the self-generated PTK. Thereby, connection between the PC 70 and the printer 20 is established, and encrypted communication between both of them based on the PTK is enabled. As described above, the communication connection between the PC 70 and the printer 20 is established with using a cable.

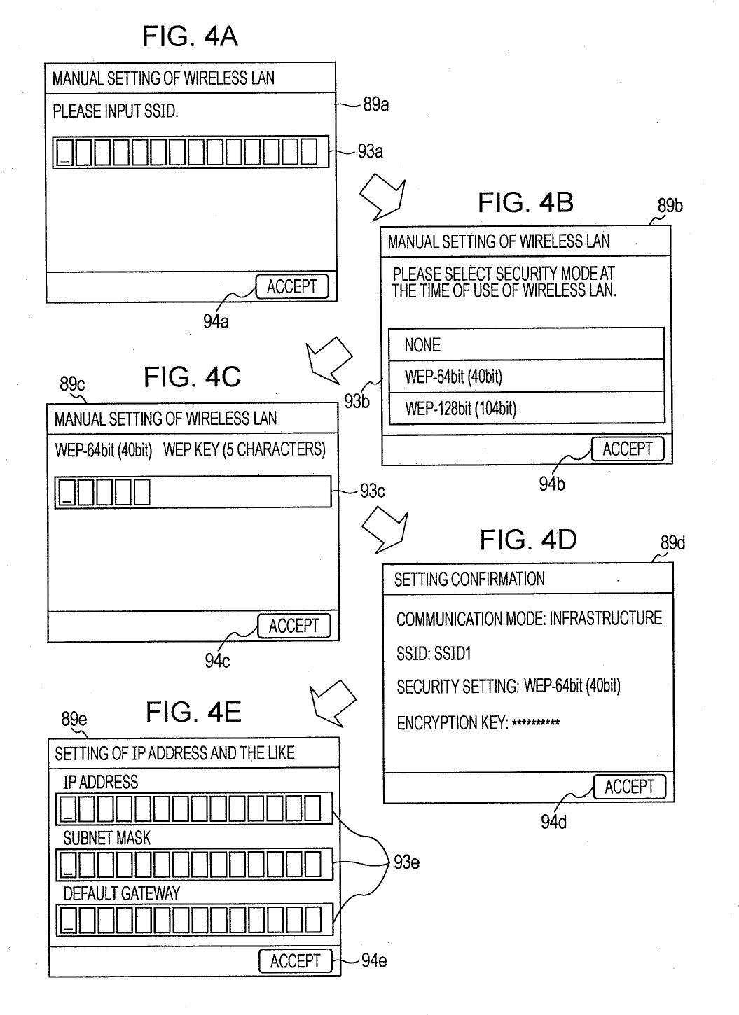

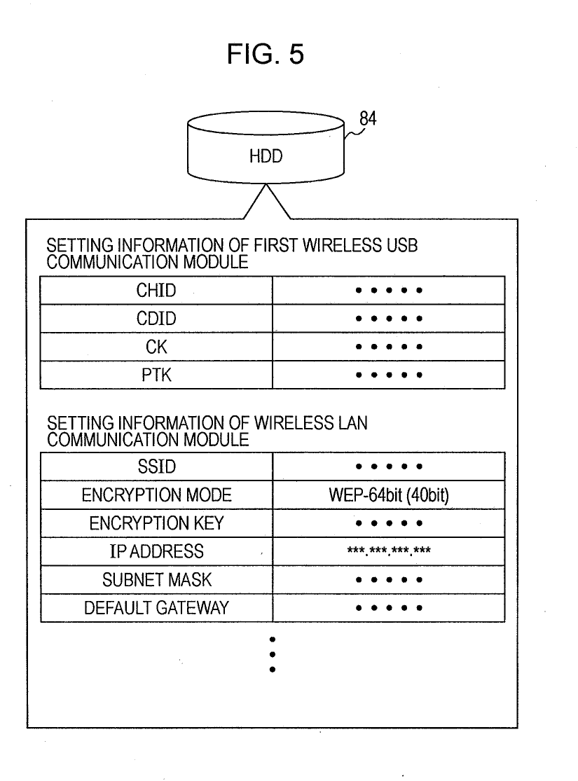

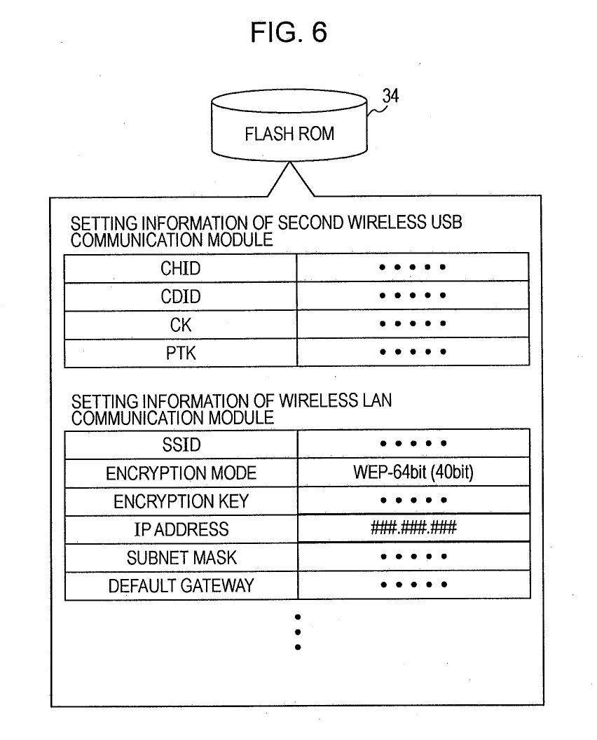

Subsequently, the CPU 81 allows the USB controller 91 to perform a USB device enumeration process, and recognizes the printer 20 (step S130). Subsequently, the CPU 81 sets the SSID in an infrastructure mode (step S140). Specifically, the CPU 81 displays an SSID input screen 89a exemplified in FIG. 4A on the display 86, and the user inputs the SSID to an input box 93a by operating the input device 87 and then clicks the accept button 94a, thereby setting the SSID. Subsequently, an encryption mode is set (step S150). Specifically, the CPU 81 displays an encryption mode setting screen 89b exemplified in FIG. 4B on the display 86, and the user selects an encryption mode in an input box 93b by operating the input device 87 and then clicks the accept button 94b, thereby setting the encryption mode. A WEP-64 bit (40 bit) is selected herein. Subsequently, an encryption key is set (step S160). Specifically, the CPU 81 displays an encryption key input screen 89c exemplified in FIG. 4C on the display 86, and the user inputs an encryption key to an input box 93c by operating the input device 87 and then clicks the accept button 94c, thereby setting the encryption key. Subsequently, setting contents are confirmed (step S170). Specifically, the CPU 81 displays a confirmation screen 89d exemplified in FIG. 4D on the display 86, and the user confirms setting contents and holds down the accept button 94d by using the input device 87, thereby confirming the setting contents. Subsequently, the CPU 81 stores the SSID, the encryption mode and the encryption keys (the SSID and the like) input in steps S140 to S160 in the HDD 84, and transmits those to the printer 20 through the transceiver 92 (step S180). The CPU 31 of the printer 20 receiving the SSID and the like stores the SSID and the like in the flash memory 34, and determines those as one of communication conditions of the wireless LAN communication module 48. Subsequently, the IP address, the subnet mask, and the default gateway (the IP address and the like) are set (step S190). Specifically, the CPU 81 displays a screen 89e for setting the IP address and the like exemplified in FIG. 4E on the display 86, and the user inputs the IP address and the like to three input boxes 93e by operating the input device 87 and then clicks the accept button 94e, thereby setting the IP address and the like. Subsequently, the set IP address and the like are transmitted to the printer 20 (step S200), and the current routine is terminated. The CPU 31 of the printer 20 receiving the IP address and the like stores the IP address and the like in the flash memory 34, and determines those as one of the communication conditions of the wireless LAN communication module 48. As described above, in the above-mentioned steps S140 to S160 and S190, the user inputs information by using the input device 87 of the PC 70 which is more convenient to input than use of the operational panel 50 of the printer 20 because it is inconvenient to input the information with the display section 51, of which a size is smaller than that of the display 86, and the operational section 52 of which the number of buttons is small. Furthermore, the set SSID, the IP address, and the like are also transmitted to the printer 20 without using a cable. Here, FIG. 5 shows the setting information stored in the HDD 84 at the time of termination of the wireless LAN setting process routine of FIG. 2. Furthermore, FIG. 6 shows the setting information stored in the flash memory 34 at the time of the termination of the wireless LAN setting process routine of FIG. 2. The same information other than the IP address is stored in the HDD 84 and flash memory 34.

Here, correspondence relationship between components of the embodiment and components of the invention is clarified. The wireless USB communication system 10 of the embodiment corresponds to the wireless USB communication system of the invention, the PC 70 corresponds to the USB host, the printer 20 corresponds to the USB device, the first wireless communication module 90 corresponds to the first communication module, the second wireless communication module 60 corresponds to the second communication module, the wireless LAN communication module 48 corresponds to the another communication module, and the flash memory 34 corresponds to memory. Furthermore, the PC controller 80 corresponds to the host control section, and the printer controller 30 corresponds to the device control section.

According to the wireless USB communication system 10 of the embodiment described above in detail, the wireless LAN communication module 48 belonging to the printer 20 can be set without using a cable in the simpler way. Generally, the wireless LAN communication module 48 has a plurality of setting items, and it takes time to input the setting items by using the operational panel 50. Hence, it is preferred to apply the invention.

Furthermore, the invention is not limited to the embodiments mentioned above, and may be modified in various forms without departing from the technical scope of the invention.

For example, in the embodiment mentioned above, the setting of the wireless LAN communication module 48 was described, but the invention may be applied to the setting of the wired LAN communication module 46. In this case, it is preferred to perform the process in steps S110 to S130, S190, and S200 of the wireless LAN setting process routine of FIG. 2.

In the embodiment mentioned above, the wireless USB communication system 10 was described, but the invention may be applied to anything including the USB host, such as a PDA, other than the PC 70 and the USB device, such as a digital camera, other than the printer 20 if only the USB device has a communication module other than the wireless USB communication module and the USB host and the USB device can be connected on the basis of the wireless USB standard.

What is claimed is:

1. A wireless USB communication system comprising:
a USB host that has a first communication module for performing communication based on a wireless USB standard; and
a USB device that has a second communication module for performing communication based on the wireless USB standard, another communication module for performing communication based on a standard other than the wireless USB standard, and a memory capable of storing various information,
wherein the USB host establishes connection with the USB device by sharing a connection context with the USB device in an in-band method based on the wireless USB standard, and subsequently transmits communication information on a communication condition of the another communication module to the USB device through the first communication module, and
wherein the USB device establishes connection with the USB host by sharing the connection context therewith and subsequently stores received communication information in the memory and sets a communication condition of the another communication module on the basis of the received communication information when receiving the communication information from the USB host through the second communication module.

2. The wireless USB communication system according to claim 1, wherein the another communication module is a wireless LAN communication module or a wired LAN communication module.

3. The wireless USB communication system according to claim 1,
wherein the USB host is a PC, and
wherein the USB device is a printer.

4. A USB host comprising:
a first communication module that communicates with a second communication module belonging to a USB device on the basis of a wireless USB standard; and
a host control section that establishes connection with the USB device by sharing a connection context with the USB device in an in-band method based on the wireless USB standard, and subsequently transmits communication information on a communication condition of another communication module for performing communication based on a standard other than the wireless USB standard belonging to the USB device to the USB device through the first communication module.

5. A USB device comprising:
a second communication module that communicates with a first communication module belonging to a USB host on the basis of a wireless USB standard;
another communication module that performs communication based on a standard other than the wireless USB standard;
a memory that is able to store various information; and
a device control section that establishes connection with the USB host by sharing a connection context with the USB host in an in-band method based on the wireless USB standard, and subsequently stores received communication information in the memory and sets a communication condition of the another communication module on the basis of the received communication information when receiving the communication information of the communication condition of the another communication module from the USB host through the second communication module.
